(19) United States
(12) Patent Application Publication
(10) Pub. No.: US 2018/0053128 A1
(43) Pub. Date: Feb. 22, 2018

(54) SYSTEM AND METHOD FOR AUTOMATED DISCOVERY AND RANKING OF REGULATORY COMPLIANCE RISKS

(71) Applicant: Gunther Costas, Ponce, PR (US)

(72) Inventor: Gunther Costas, Ponce, PR (US)

(21) Appl. No.: 15/680,020

(22) Filed: Aug. 17, 2017

Related U.S. Application Data
(60) Provisional application No. 62/376,242, filed on Aug. 17, 2016.

(51) Int. Cl. G06Q 10/06

(52) U.S. Cl. CPC G06Q 10/0635

(57) ABSTRACT

Method and systems for the collection of documents that belong to a regulatory corpus, and the building of a data structure that will capture the relationships between their constituent parts. Said data structure will be used to build other data structures that map the topics present at each level of the corpus constituents, and automated classification models to match new, unseen documents that are not part of the regulatory corpus but nonetheless need to comply with it, with those areas of the regulatory corpus that they pertain to. A method to further process those compliance documents to determine how well they are covering the relevant sections of the regulatory corpus, and therefore highlight areas where there is heightened regulatory risk. The regulatory corpus can be augmented by international standards, regulatory agency decisions, guidance documents, court cases, expert commentary, and other sources of regulatory insight. Since regulations are routinely updated, new regulations promulgated, and others repealed, and new decisions and guidance issued by regulatory agencies, bodies, and experts, the process mentioned above will be done iteratively to maintain the validity of the regulatory corpus. Individuals and companies will be able to access the system and determine the regulatory risks in their existing documents, or those documents that they are planning to issue to guide their internal operations.

### FIELD OF THE INVENTION

The present disclosure conveys systems and methods for the aggregation of documents in a regulatory corpus, its organization of the component entities of the documents in the corpus in data structures, the hierarchical, recursive, and iterative processing of those elements to create automated classification models and perform automated topic extraction. In this context, a regulatory corpus is a collection of documents comprising state and federal regulations, interpretative case law and memoranda, industry guidance and best practices, internal company rules and regulation, audit findings, and other similar documents. Furthermore, these steps will be taken so that new documents, which evidence a company's or an individual's compliance with a regulatory scheme, are automatically analyzed by the system we are describing in order to determine the extent and degree of their regulatory compliance. The technologies used in this invention relate to the fields of Artificial Intelligence, Machine Learning, Natural Language Processing, Information Technology, Information Retrieval, Data Mining, and Computer Science. The application of this invention includes but is not limited to any individual or organization that needs to comply or potentially comply with the standards set forth by a governmental or private organization. These systems and methods can be embodied in computer code, and the realization of its activities may be exposed to its users in the form of a desktop application, a web page, a set of Application Programming Interfaces (API), automated digital assistant (such as a chatbot), and other methods and means.

### BACKGROUND OF THE INVENTION

Regulatory compliance is of paramount importance in today's economy. The typical company and individual, engaged in any type of business enterprise, development of technology, or economic activity, is subject to numerous local, countrywide, international, and trade association regulations. To show how this is increasing the complexity of doing business, let's take as an example the Code of Federal Regulations (CFR), which embodies the general and permanent rules and regulations (also referred to as the administrative law) of the Federal Government of the United States of America. As of 2016, the CFR contains 50 subject areas, known as titles, and spell out the federal regulations governing areas such as Business Credit and Assistance (Title 13), Navigation and Navigable Waters (Title 33), Banks and Banking (Title 12), and Food and Drugs (Title 21). In 2003, the whole of the CFR consisted of 144,177 pages of rules and regulations. By 2013, the CFR had grown to 175,496 pages, an increase of almost 22% in a decade's time. On average, the CFR has increased by more than 3,000 pages per year. Regulatory compliance is not optional. Many areas of the regulation cover standards essential to society, such as those that ensure fairness in business, security in the transportation of passengers and goods, economic justice, civil rights, non-discrimination, and patient safety. Failure to comply with regulations not only imperils law and order, public safety, and economic opportunity, but also expose companies, their officers, employees, and individuals to civil and criminal penalties for non-compliance.

Companies and individuals that are involved in regulated industries must develop written policies, procedures, and work instructions that detail how they are complying with the regulatory standards applicable to their industry. Governments expect that these documents be periodically reviewed and updated to reflect their continuous improvement efforts, as well as changes in law, regulation, and the agencies' current regulatory stance, as evidenced by their recent regulatory actions.

In order to ensure they are fulfilling their regulatory obligations, companies devote significant resources to compliance activities in the form of the headcount employed performing these activities within corporations and external consultant expenses, for example. For many industries, such as banking, pharmaceuticals, and medical devices, regulatory review and compliance determines the speed with which they can bring their innovations to the market.

Many new rules and regulations have been proposed as the result of corporate malfeasance and the damage to the public (including consumers and investors) such behavior entails. For example, and as the result of accounting scandals in firms such as Enron and WorldCom, the United State Congress passed the Sarbanes-Oxley act, also known as the Public Company Accounting Reform and Investor Protection Act, which was signed into law by President George W. Bush in 2002. While the Act looks to curb practices that have led to corporate bankruptcies, employee dismissal, investor fraud, and civil and criminal penalties for the corporate officers involved, in 2004 it was estimated that complying with the Act cost US companies between $5.5B to $6B, a figure that has only increased since then. See, for example, http://www.carrtegra.com/blog/create-the-minimum-cost-route-to-sarbanes-oxley-compliance.

Another example is the Dodd-Frank Wall Street Reform and Consumer Protection Act, signed into law by President Barack Obama in 2010. The passage of this Act was motivated by financial institution practices that contributed to the Great Recession of 2008. Among its provisions, the Act established tighter scrutiny of how financial institutions create and market their financial products, and establishes new audit and investigation powers within existing or newly created federal agencies to ensure that the Act's provisions are being met. Though almost no one expresses that reforming the way financial institutions work was unnecessary, especially after their unprecedented taxpayer-backed bail out, the cost of complying with the Act's provisions related to mortgage lending has been estimated by some to be in the range of $24B. See, for example, https://www.americanactionforum.org/research/dodd-frank-at-5-higher-costs-uncertain-benefits/.

This is to show that although rules and regulations are essential to well-functioning economy and fair markets, the cost of complying with them is in no ways negligible, and inventions that help companies and individuals automate parts of the regulatory compliance process are an important contribution to the state of the art.

Regulatory compliance is not just about meeting the expectations of regulatory bodies of a single country. Companies that export their products and services to other countries will also need to comply with those countries' regulations, and there are international trade agreements that also come into play when goods and services cross-political boundaries. Furthermore, a regulatory document may reference international and trade standards, incorporating them into the corpus of regulations with which a company may need to comply in many situations.

At present, highly trained, heavily sought after, and well-compensated professionals perform regulatory review activities. The performance speed, thoroughness, and throughput of these tasks within a company depend on the size of their regulatory review department and the amount of expense incurred in hiring outside consultants. Verifying regulatory compliance, and continuously reviewing business practices and evidenced by the artifacts generated within a company (internal policies and procedures, technical reports, validation reports, emails, chat logs, process logs, employee training materials, qualification reports, CAPA investigations, customer complaint investigations, device history records, employment agreements, internal/external social media postings, for example) has become a source of great expense and risk, especially for smaller companies and individuals.

On the other side of this equation are the regulatory agencies that receive and review documents from companies and individuals either as part of an investigation, or through prescribed regulatory review processes. For example, new drugs and medical devices in the United States need to receive pre-market approval from the Food and Drug Administration (FDA). As part of those approvals, companies need to submit numerous documents that agency personnel then review to ensure that beyond the safety and effectiveness of the product being submitted, the processes the company used to develop and manufacture the product followed the regulation, and that there is written evidence that this is the case. A single submission may consist of many thousands of pages of documents, whose thorough and timely review is critical in fulfilling the regulatory agency's mandate: ensuring patient safety and help bring life-saving innovations to consumers as soon as possible. Regulatory agencies such as the FDA are hard pressed to perform these reviews in a detailed and expedited manner. Still, the regulatory review process does not stop when the agency approves a product or service. For example, certain changes in labeling, intended use, and manufacturing processes require the FDA to receive, review, and approve further documents. When regulatory agencies perform routine or for-cause inspections, an investigator will typically need to review many more documents to help ensure that the company's policies and procedures thoroughly meet the applicable regulations, and that the company has written evidence that they are following those procedures in all their applicable business processes.

To make matters even more complex, regulatory agencies and their investigators have flexibility in interpreting regulations—for example, there could be differences in how district offices or specific auditors tackle a regulatory issue. Moreover, a regulation's interpretation evolves through time—precedent, in the form of inspections and litigation in different states, for example, influence how regulations are interpreted going forward. Companies and individuals with a poor regulatory track record risk much more thorough inspections, since the perceived increased risk of non-compliance makes regulators both look at a wider scope of business processes, and go into more detail of how they are performed within a company and the type of evidence the company collects to document their compliance.

Companies in the smaller end of the spectrum, as well as individuals, need to divert significant resources to regulatory compliance, which increases both their consumption of cash and risk of going bankrupt before bringing a product to market. At the other end of the scale, big multinational corporations must ensure a high level of compliance throughout multiple departments, business processes, business units, and manufacturing locations throughout the world. Regulatory agencies frequently expect remediation activities throughout a company once the agency finds, or the company itself identifies, an issue at one site. This adds another input a company needs to consider when judging their regulatory compliance risk—the product of their own internal findings, audits, and investigations.

To give an idea of the size of the problem being addressed by this invention, during the 2015 fiscal year, the United States Securities and Exchange Commission (SEC) reported over 800 enforcement actions, which included 507 violations of federal securities laws, and 300 were actions against entities that failed to provide the required evidence of their regulatory compliance on a timely manner. The aggregate cost to regulated entities, in the form of monetary disgorgement and penalties, exceeded $4B. See, for example, https://www.sec.gov/news/pressrelease/2015/245.html. Had regulated entities detected that they were violating securities laws or regulations, or that they had failed to provide the evidence of their regulatory compliance to the SEC, a significant portion of those costs may have been avoided. In addition, the SEC must have invested an enormous amount of person-hours in carrying out these investigations, and there is always the question of whether there are areas being missed due to the sheer number of regulated entities in the United States, and the limited number of investigators within the SEC.

Taking the pharmaceutical market as another example, in 2015 the FDA issued over 900 findings specifically due to lack or inadequate written procedures alone. See, for example, https://www.fda.gov/ICECI/Inspections/ucm481432.htm#Drugs. If the offending company or individual performed a more thorough review of their written policies and procedures, compared them with the applicable regulation, and fixed any areas of weakness prior to the agency's intervention, prevention of these findings would have almost been certain. That is only a small slice of the findings by just one regulatory agency, in one specific type of regulated economic activity, and a conservative estimate of the aggregate company remediation effort exceeds $1B. If not addressed in a timely and satisfactory manner, or from the outset due to their severity, the findings may bring further consequences that can even bar a company from releasing new products, removal of existing products from the market, personal injury and investor lawsuits, and legal penalties including criminal prosecution.

Systems and methods for automated assessment of regulatory compliance are known in the art but these systems have serious deficiencies. For example, US Patent Publication No. 2013/0346328 teaches a system for distributing requests for artifacts to a regulated institution for risk assessment. According to said publication, risk rating is assessed for an institution based on data obtained from publicly available sources and employee-given response to a questionnaire. Based on the assessed risk, a set of policies and procedures is created for the institution to implement in order to achieve or maintain compliance, and the institution is notified of the required policies and procedures. However, this system and method cannot determine whether a particular document is compliant with a regulation and/or how well the regulation is covered by the document. In addition, said publication relies on employee surveys, which add complexity to an already complex business process.

Furthermore, U.S. Pat. No. 8,818,837 teaches a system wherein a computer enabled database and associative linking mechanism expertly ties rules and regulations, and survey questions, to one or more of a limited but comprehensive set of pre-defined, discrete compliance objectives that logically group and collectively span the full range of compliance issues presented by the included sources. However, the system disclosed by this patent does not employ automated natural language analysis. This patent also relies on customer surveys.

Thus, there is a need in the art for automated determination of risk due to regulatory compliance. In order to overcome the shortcomings of the prior art, this system relies on machine learning techniques and natural language processing to generate a system capable of determining regulatory compliance of a text corpus (a set of documents or artifacts) related to policies and activities of an entity. The invention discussed in this disclosure automates the process of discovering and ranking of regulatory risks. It is useful for companies and individuals that must meet standards and regulations promulgated by a government, international body, non-profit, court of law, public or private companies and individuals. Also, regulatory agencies and private and public officials that must verify compliance to regulations can benefit from this invention. This invention enables a more thorough and frequent review of the regulatory compliance state of a business operation, highlighting the areas of compliance risk to enable corrective action in an effective and timely fashion.

### SUMMARY OF THE INVENTION

The entities within which the automated discovery and ranking of regulatory risks applies include individuals, corporations, and government entities. It may include, for example, a pharmaceutical company, a medical device manufacturer, a physician performing clinical research, a company developing new clinical testing procedures and products, financial institutions such as banks and credit unions, universities, educational institutions, or any other legal entity that is subject to governmental, quasi-public, international, and private regulations. The compliance risk can arise from not following governmental laws, regulations promulgated by regulatory agencies, regulatory guidance documents, proposed laws and regulations, technical and academic articles, internal findings, posts in internet forums and social media, internal policies and procedures, and internal communications in the form of documents, emails, and chats, for example.

An exemplary embodiment of this invention follows. A pharmaceutical company is doing business within the United States, and is therefore subject to the Code of Federal Regulations (CFR). Furthermore, the company is performing manufacturing operations. It needs to verify that a particular document or set of documents show that it is complying with federal regulations. The company submits those documents to the system we are proposing. The system automatically determines which parts of the CFR apply (in this case, within Title 21 of the CFR), and how well the pertinent areas of the regulation are being covered by the documents, showing any gaps of required information that is not presented in the documents. The system returns a risk rating of how well the documents fulfill the regulatory requirements they address, and which applicable regulatory areas the documents do not adequately address. The method through which the system receives the documents include email services, upload to a web application, Application Programming Interfaces (API) linked to the company's document management systems, or a chatbot, to which documents are sent and the system answers with the deliverables mentioned above, or specific questions can be directed.

In another exemplary embodiment, the system allows continuous review of the documents to provide updated risk ratings. The updated risk ratings are obtained based on modifications to the base documents, updated regulations (and/or regulatory interpretation), internal or external regulatory findings, or new data flowing into the system from the sources mentioned above. In another exemplary embodiment, the system can receive an issue tracking process as input, so that the system's algorithms can consider internal company findings in a timely manner, thus, helping companies address their issues holistically rather than in geographical or business line silos, as applicable.

Another embodiment, which can be stand alone or integrated into the embodiment mentioned above, is one in which the regulated entity provides the system with the policies (such as employment non-discrimination, establishment of quality systems or financial review boards), procedures (such as hiring procedures), and work instructions (such as the steps necessary to obtain an export license) and any other training material it developed to ensure its compliance with regulations. The embodiment includes the provided data in its regulatory compliance risk model, together with governmental and other regulations that are within the scope of the entities business operations. The entity will then provide the artifacts (such as documents, business transactions, etc.) that it generates to show substantive compliance with the regulations and its own policies and procedures. The embodiment will then perform the same type of analysis described above. However, it will also provide a regulatory and internal policy and procedures risk rating to the business process (as evidenced by the artifacts supplied to the system), and also highlight how well documented (again, as evidenced by the artifacts supplied to the system) are the areas covered by the entity's policies and procedures, as well as those applicable regulations. To emphasize a point mentioned before—for regulatory agencies, it is not only important that there exist written policies and procedures that say how regulated entities will comply with the applicable regulations; it is also important that the entities have objective, documented evidence that it is following those procedures thoroughly.

In another embodiment, which can be combined with those described above, the regulations and other documents, and the regulated entity's policies and procedures, or the artifacts they generate to demonstrate regulatory compliance, use words with similar meanings. A strict word-by-word comparison may show that the regulated entity has compliance risks that are not there in reality, therefore generating a false positive. For this reason, the system may convert words into a canonical form, which will ease the comparison process and reduce the number of false positives. In this context, a false positive occurs when the system reports an issue in complying with a regulation, or that there are areas of the regulation that are not being met. Conversely, a false negative occurs when the system fails to report an issue in complying with a regulation, or that there are areas of the regulation that are not being met.

Companies must have policies and procedures, as well as records that provide evidence of following such policies and procedures, related to specific areas of the regulatory corpus. Which regulations from the corpus it must follow are determined by the business activities in which the company incurs, or the types of products it is offering to the public. For example, a medical device company must comply with 21 CFR 820, while 19 CFR 146 specifies how companies must conduct business operations while operating within a Foreign Trade Zone.

In another embodiment, which can be combined with those described above, when presented with a set of policies and procedures from a company, the system will determine which areas of the regulation apply to those policies and procedures, using classification models. In order to provide a full assessment of a company's regulatory risks, the system must determine which other areas of the regulatory corpus a company needs to address, even if it was not provided with specific policies and procedures that can be tied to those areas of the regulation. In order to do this, the system measures the distance between the regulatory areas for which the company did provide policies and procedures, and other areas of the regulatory corpus. This distance metric may be calculated using a combination of two factors: how close the regulatory sections are within the structure of the regulatory corpus (for example, 21 CFR 820.100 is a neighbor of 21 CFR 820.90, since they have the same parent, namely, 21 CFR 820) and the topic distance between them—for example, 21 CFR 820.120 and 21 CFR 801 are topically close, since both have to do with medical device labeling. This topical distance can be measured using methods such as cosine similarity, and algorithms such as Doc2Vec. Physical distance and topical similarity measure can be combined using methods such as Euclidian distance. It is also possible to determine other distance measurements, and combine them using other metrics. The system will judge the likelihood of the applicability of those regulations in direct proportion to the calculated distance, and will have a configurable cutoff so that regulations that exceed that distance will not be used in the regulatory risk analysis. That cutoff can also be algorithmically determined by using machine learning techniques that take examples in which human experts have judged the appropriate cutoff and the output variable, and the words or words with similar semantic content as the input features for the algorithm. Examples of those machine learning algorithms include linear regression, support vector machines, and neural networks (algorithms in which the input is a feature set and the output is a number).

In another embodiment, which can be combined with those described above, received documents can be assigned roles depending on how the system will be using them. For example, a document can be received by the system solely for being analyzed, while another document can be received for being analyzed and to train the system. The role of a document can be updated based on the results of the analysis or by a human expert determining what the document's role should be. For example, if a document's compliance level is determined to be over 95%, then it can be made part of the regulatory corpus and be used to train the system.

Another embodiment which can be combined with those described above, can automatically detect the language of the regulatory corpus and the regulated entity's documents, so the text analysis can be done using the appropriate language rules. Additionally, the written language of the regulations and a regulated entity's documents could differ. In these cases, the process may also involve automated translation using well-established algorithms.

### BRIEF DESCRIPTION OF THE DRAWINGS AND FIGURES

FIG. 1 shows a block diagram that illustrates how the system processes regulations, expert opinion, regulatory actions, standards, and other reference text. It also shows the result of the process, which is a hierarchical classification model and a hierarchical topic model. FIG. 1 provides high-level steps of the internal process of the system, implemented using databases, computer code, and computing processing devices.

FIG. 2 shows a block diagram of how a regulated entity uses the system. After execution of the steps shown in FIG. 1, a regulated entity submits the documents to be analyzed through a plurality of means including emailing, upload to a web service, API link to its document management system, for example. The system extracts the relevant terms from those documents, and automatically determines the areas of the regulation to which the documents pertain. The system will then determine both how well documents cover the pertinent areas of the regulation, and how well the applicable regulations are covered by the documents.

FIG. 3 shows a block diagram of another embodiment, which receives the regulated entities internal policies and procedures as inputs. This embodiment may be combined with that discussed in FIGS. 1 and 2.

FIG. 4 shows a block diagram of the embodiment discussed in FIG. 3 as used by a regulated entity. Given a set of artifacts (documents, business transactions, emails, etc.), the system will output how well those artifacts are showing compliance to specific policies and procedures, and how well those policies and procedures are being evidenced by the artifacts.

FIG. 5 shows a flowchart of an embodiment which loads a regulatory corpus and documents to train said corpus to create classification and topic models. The created models are then used to analyze the documents received by the system and determine the parts of the regulatory corpus that apply to the received documents and the compliance level at which the documents cover the applicable regulations. This analysis results in compliance indexes reflecting how well the received documents cover specific applicable parts of the regulatory corpus and how well the applicable regulations are covered by the received documents.

### DETAILED DESCRIPTION

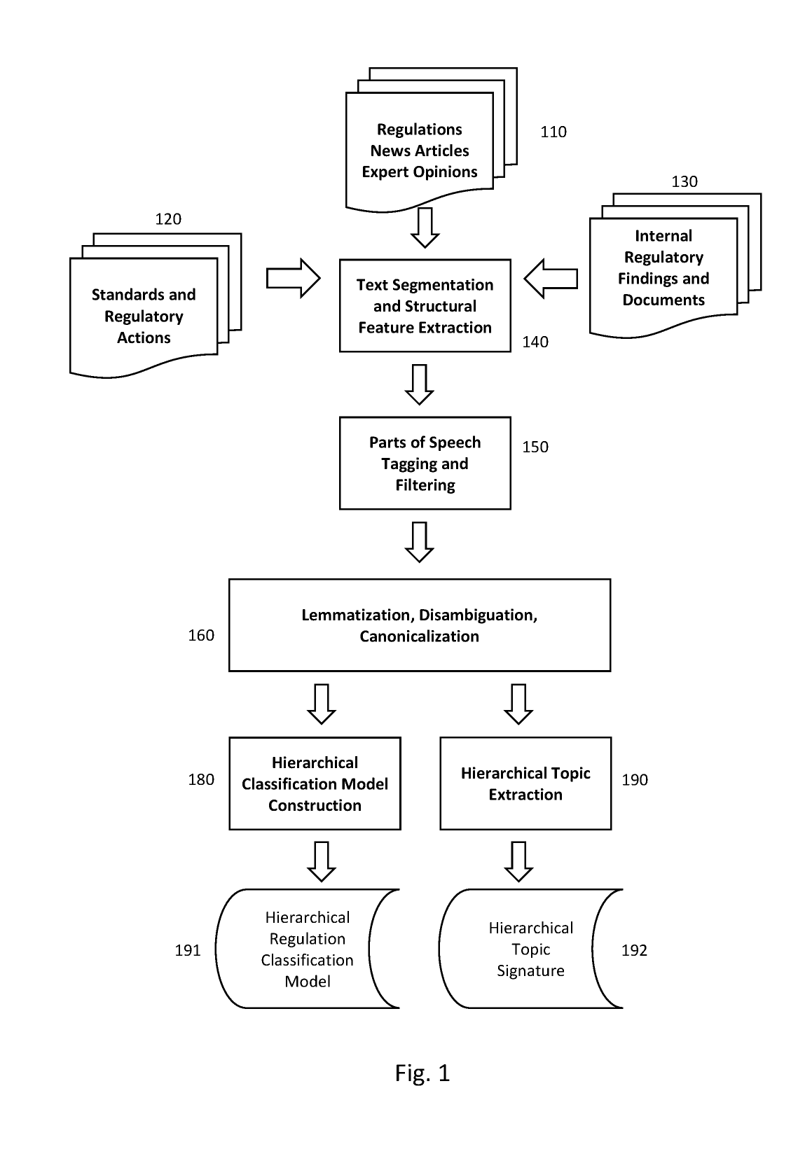

FIGS. 1, 2, 3, and 4 of the reference embodiments may consist of computer processing devices, databases, and computer code.

FIG. 1 is a block diagram that illustrates how the system will process regulations (such as the United States Code of Federal Regulations, TUV Medical Device Regulation, China Food and Drug Administration Section 36, Baser Committee Banking Regulations, or court cases where a US Regulatory Agency serves as plaintiff), regulatory actions (such as FDA 483 Form or FDA Warning Letters), standards (such as ISO 9000, ISO 9001, ISO 45001 or ISO 13485), expert opinion, and other reference text. The input texts used as examples in blocks 110, 120, and 130 can be contained in a database, or provided through a web service or other electronic means. The data may already be labeled with, for example, the name of the regulation, and the different components of it.

One of the regulations used as an input could be the Code of Federal Regulations (CFR). The CFR is divided in Titles, which detail with different areas of the economy, government, or contractual relationships. Within a Title, there can be different Chapters for specific areas or agencies. For example, Title 21 consists of three Chapters, one each for the regulations and administrative law related to the Food and Drug Administration (FDA), the Drug Enforcement Administration (DEA), and the Office of National Drug Control Policy. Within a chapter, there can be different Parts, each for a more specific area. Part 58 of Title 21 (referred to as CFR 21 Part 58) deals with the Good Laboratory Practices (GLP), which define the regulatory expectations for laboratories that perform patient blood work, among other tests. For instance, this section brought many problems to Theranos.

In an exemplary embodiment, block 140 automatically parses a hierarchy, such as the hierarchy found in the CFR, when available. Hierarchies can also be hand-annotated by experts in the regulatory or technical area. For example, an engineer can divide a document into sections pertaining to specific subjects before sending it to the system to be analyzed. Those separate sections can define the hierarchy for the classification model. Block 140 stores these references to specific parts of the regulatory corpus, for example, so the system can output the page or subsection of the regulation that the documents later presented to the system do not adequately cover. Block 150 will take the output of block 140 to perform part of speech tagging and filtering. In block 150, the system discards certain parts of speech (such as prepositions) that do not convey a significant amount of information. Block 160 will then perform further processing, with the goals of obtaining a standard representation of the meaning of the input texts by finding words or sequences of words with similar semantic content. This can include word lemmatization, disambiguation, and canonicalization. The output of block 160 does not only include a set of specifically processed words, but also combination of words (bigrams, trigrams, etc.) so that the system processes the fullest meaning of the input text. Block 160 then performs lemmatization by implementing well-known algorithms. The system can further use algorithms such as Word2Vec for disambiguation and canonicalization.

In this exemplary embodiment, the output of block 160 serves two main purposes. The first is to create the Hierarchical Classification Model Construction noted in block 180, and the Hierarchical Topic Extraction in block 190. Block 180 is a classification model, implemented by a supervised machine learning means, trained using the output of block 160. It is hierarchical because the structure of the documents establishes a hierarchy—either directly (as in the case of the CFR), inferred by their content, or by the hand-annotation of experts.

In addition to the labels, which were extracted in block 140, the other components that a supervised machine-learning algorithm needs to train the system are the text structure features. In this case, since we are working with text, the text structure features are the output of block 160. The goal of the model is to, for example, first determine which Titles of the CFR apply, and within those Titles, which Chapters, and within the Chapters, the Parts, and so forth. Block 180 outputs the Hierarchical Regulation Classification Model into block 191. There are well-known supervised machine learning algorithms for text classification, which include Naïve Bayes, Bayes Networks, and Support Vector Classifiers.

The other purpose for which the system, in this embodiment, uses the output of block 160 is to create the Hierarchical Topic Model, which is the output of block 190. A topic is a Natural Language Processing (NLP) term that consists of a word or a set of words. For example, given a set of documents, a topic can be determined to be “genetic engineering safety” and another “genetic engineering applications”. There are well-known algorithms to extract topics from a set of documents in an automatic fashion. Two of the most widely known and used are Latent Semantic Indexing (LSI) and Latent Dirichlet Allocation (LDA). The topics found through automated means may be augmented by those determined by human experts, and included in the output of block 190. The amount of words in a topic depends on the granularity or level of depth at which the analysis of documents will be made. Block 190 produces block 192 as its output, which is comprised of a listing of the topics present in the hierarchy of documents and sub documents extracted in block 140, the strength of the topics in them, and a model that, given new documents, provides as its output the strength of those topics in the documents.

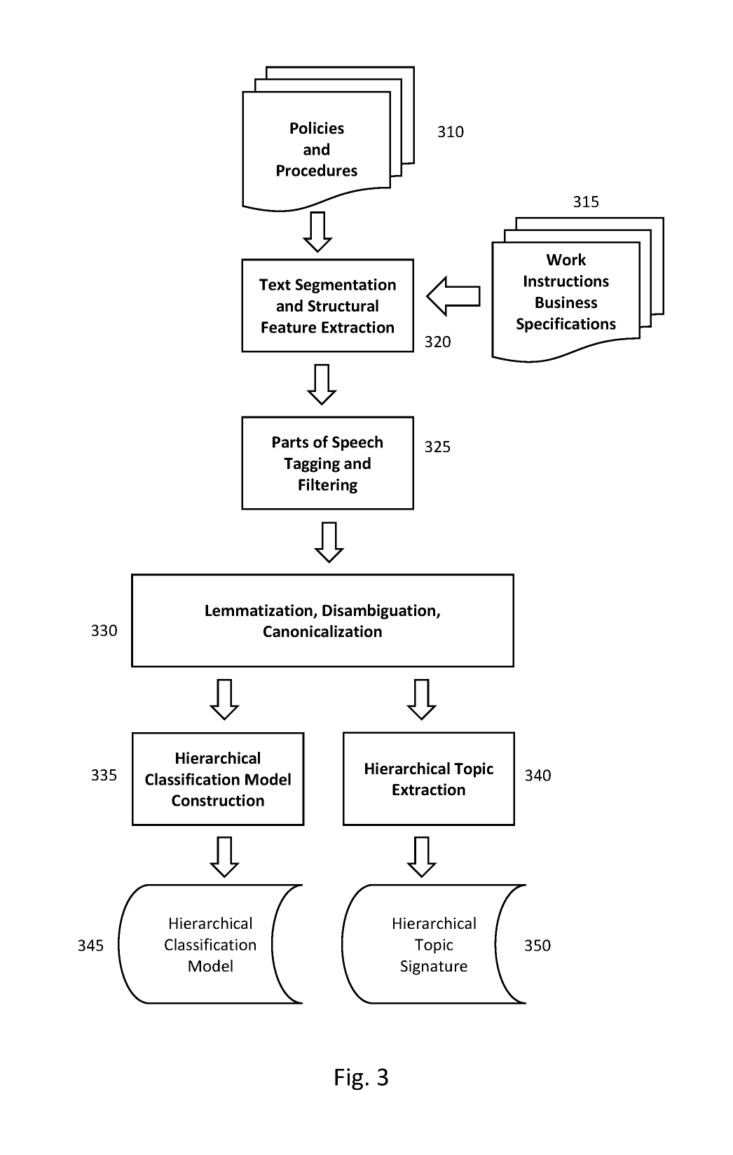

It is important to note that FIG. 1 of this embodiment is not a one-off process, since it can be continuously updated as new data sources are available. The new data sources may include additional documents in the regulatory corpus. For the embodiment in FIG. 3, new data sources may include the policies and procedures that a company recently implements, policies and procedures that are incorporated to the company's corpus because of an acquisition, or the specifications of newly developed business processes, products, or services.

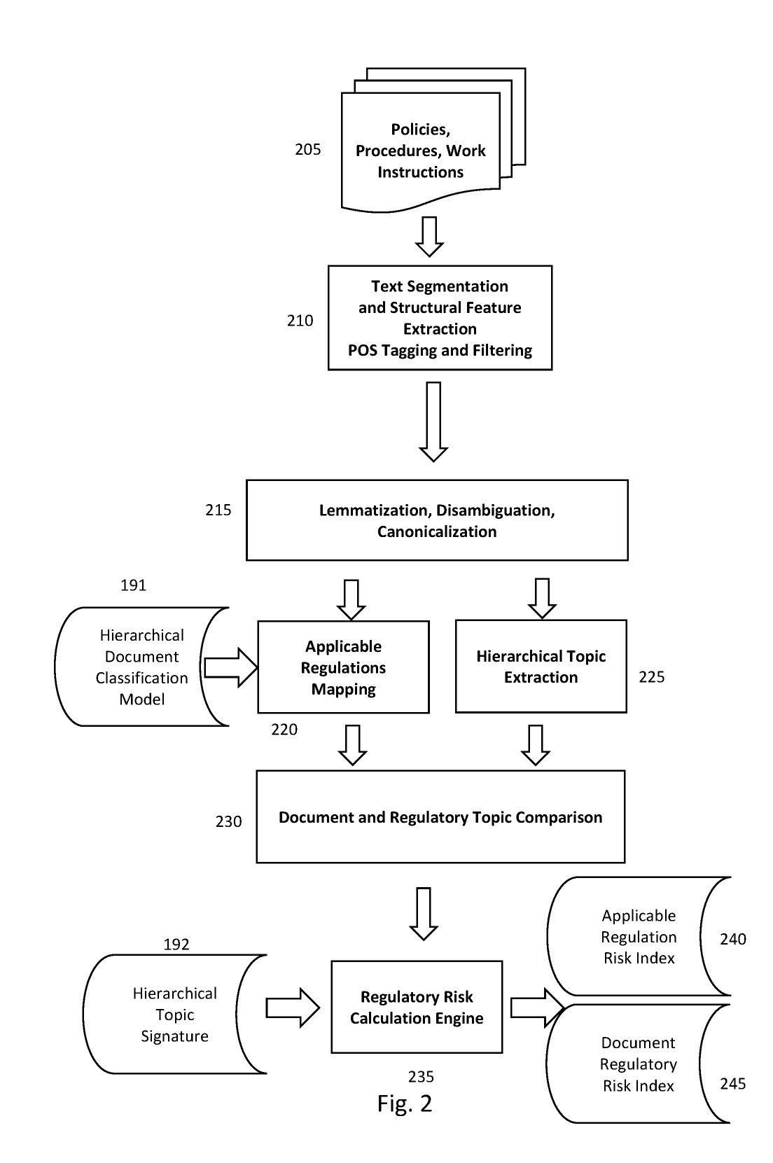

Additionally, the embodiment in FIGS. 1 and 2 can be used recursively, in the sense that once policies and procedures that have a high level of compliance are identified as the output to FIG. 2, they can become the input to FIG. 1 and use the models FIG. 1 generates to calculate the regulatory risk of other documents input in FIG. 2 with respect to the exemplary documents given to FIG. 1. This will be useful to regulated entities since regulatory agencies do not only look for documented compliance, but also look for consistency between the documents. In this same way, documents with a poor regulatory compliance score can be input to FIG. 1, so that other documents that are given to FIG. 2 and that have the same types of deficiencies are identified as well, so companies can take action and correct those deficiencies in a timely manner.

In this embodiment, once the system has been trained as in FIG. 1, FIG. 2 can be used to automatically discover and rank regulatory compliance risks. In particular, the risks the system will be highlighting consist of applicable areas of the regulation that are not being adequately addressed by the regulated entity's policies and procedures, and the thoroughness with which it is covering those areas that are in fact being addressed. As an example of the first type of risk, a pharmaceutical manufacturer is required to have policies and procedures pertaining to equipment cleaning and maintenance (21 CFR Part 211, Section 211.67) but no documents are within the regulated entity address this area. An example of the second type of risk is that a regulated entity may have policies and procedures related to product expiration dating (21 CFR Part 211, Section 211.137), but those documents fail to mention stability testing, as required by paragraph (a) of the aforementioned regulation.

A regulated entity may wish to gauge its compliance risk within its policies, procedures, and work instructions, as noted in block 205. Policies, procedures, and work instructions constitute a hierarchy of documents. That is to say, procedures give more detail in regards to policies implementation within a regulated entity, and work instructions give systematic description on how procedures performance. Thus, a regulated entity may wish to provide its policies and procedures as inputs in FIG. 1 of the embodiment and its work instructions in FIG. 2, in order to determine how well its work instructions cover its policies and procedures, and if there are areas within its policies and procedures which are not covered by its work instructions. This idea can be recursively extended depending on the industry, business process complexity, and other factors.

In this embodiment, Block 210 will perform similar processing as block 140 does, but it is listed separately since there could be some fine-tuning that is necessary due to the input sources. For example, the inputs may be images of documents where performance of Optical Character Recognition (OCR) is necessary before further processing. Block 215 is similar to block 160, but may include additional steps if, for example, the input documents in FIG. 2 are in a different language than those in FIG. 1, and it is therefore necessary to perform automated translation as part of the canonicalization process.

The output of block 215 is presented to the model that was trained in 191, in order to determine which areas of the regulations and other pertinent texts input in FIG. 1 are related to the documents input in FIG. 2. For example, block 220 may show that a document that is provided as an input in FIG. 2 is related to 21 CFR Part 21, Section 211.137 with a certain degree of probability, and to 21 CFR Part 21, Section 211.125 with a certain degree of probability. Block 230 compares the topics extracted in block 192, for those pertinent areas of the regulation as determined in block 220, with the topics extracted in block 225. This information is then passed on to block 225 in order to determine how well a document input in FIG. 2 is covering a particular section of the regulation. Block 225 also determines which other areas of the applicable regulations are not being adequately covered by one or any of the documents provided as input in FIG. 2.

Block 240 determines how well the documents provided in block 205 cover the different areas of an applicable set of regulations inferred by the classification probabilities output in 220. That is, areas of the regulation, which are applicable but nonetheless have a low classification probability given the documents in block 205, are poorly covered and areas of high risk.

In the case of block 245, this index can be calculated by a set similarity measure, such as the Jaccard index. The Jaccard index is obtained by comparing the set of words comprising highly ranked topics of the relevant documents identified in block 220 and the topics identified in block 190 with the set of words in the topics with high ranking, for a particular document, found in block 225. If a document provided in block 205, for example, has a high Jaccard index, the risk that that document has missed important areas of highly rated classifications output in block 220 is low. If the Jaccard or other appropriate set similarity measurements are low, then the risk is high. Other measures of set similarity may also be used.

Through the use of the embodiment in FIGS. 1 and 2, a regulated entity can automatically determine how well its documents are covering the areas of the regulation that they address, and whether there are blind spots or gaps in the form of areas of regulation that apply to them, but they are not addressing. As stated above, these processes can be run continuously and/or recursively to reflect changing regulations, new documents, and new business processes, for example.

Programmatic linkage between document management systems and the embodiment described in FIGS. 1 and 2 can make the process more automatic and less human dependent. It also allows regulated entities to devote their highly skilled employees to mitigating the areas of highest risk, rather than dealing with the fallout due to patient safety issues that arise when regulations are not followed, or facing regulatory action for infractions discovered during inspections.

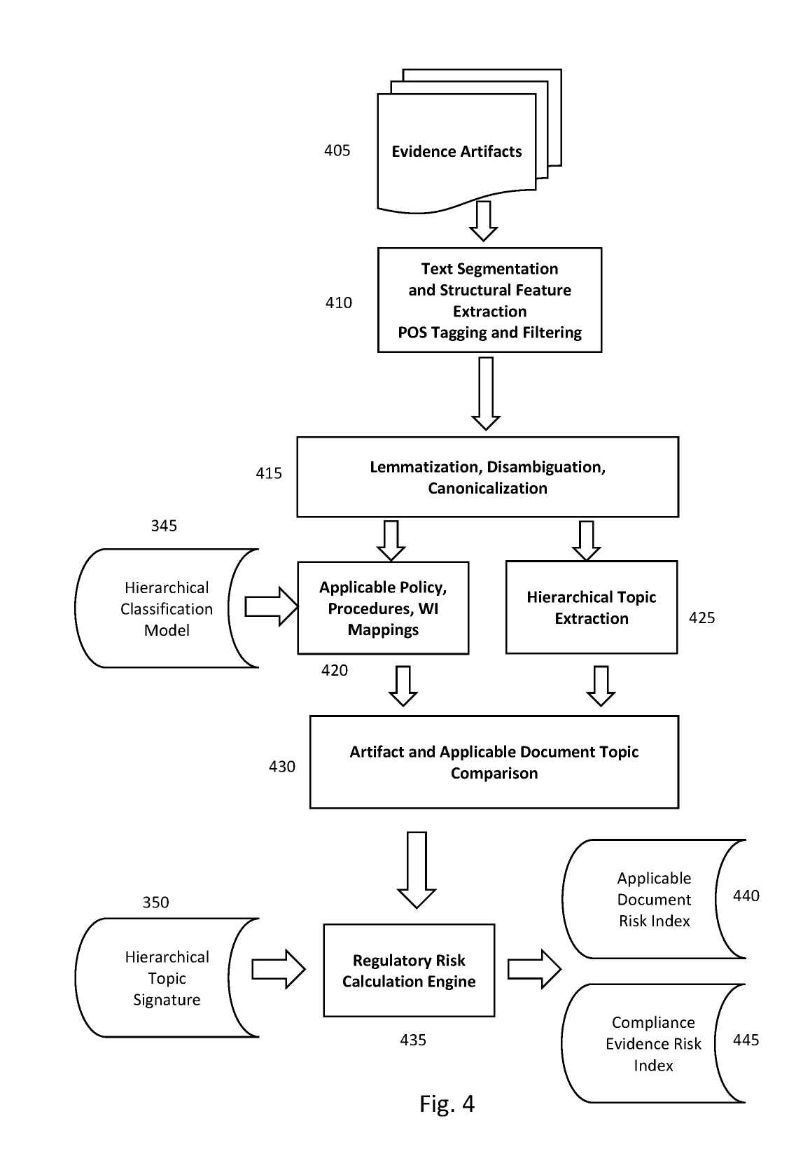

FIGS. 3 and 4 present another embodiment of this disclosure. As mentioned before, regulatory bodies expect that regulated entities develop policies, procedures, and work instructions that detail how they comply with applicable rules and regulations. More than that though, regulatory bodies expect that the entities maintain written, up to date, and objective, written evidence that shows the effectiveness of their policies, procedures and work instructions and that they are thoroughly following their own policies, procedures, and work instructions in a consistent manner.

In this embodiment, FIG. 3 is a block diagram that shows how the disclosed invention receives internal regulations created by the regulated entity, such as policies and procedures, in order to train the system and output block 345 and block 350, which are, respectively, the Hierarchical Classification Model, and the Hierarchical Topic Signature. These are analogous to block 191 and block 192 discussed above in relation to FIG. 1 of the previously described embodiment. Given a document that is collected to show the evidence of following a particular procedure, block 345 classifies which documents provided to the system in block 310 and block 315 are pertinent to the document provided. Block 350 is a topic model that defines the topics present in block 310 and block 315, and given a new document, determines the strength of those topics present in it.

Going through the block diagram in FIG. 3, block 310 may include the policies and procedures that a regulated entity develops in order to comply with pertinent regulations and standards, and block 315 includes more detailed work instructions that list the steps that need to take place in order to realize a business process. Block 315 may also include product or business process specifications. For example, for a physical product, block 315 may include dimensional characteristics, and product performance specifications. Blocks 320, 325, and 330 perform text processing operations similar to blocks 140, 150, and 160 described above, but may have slighter different parameters based on the nature of the documents being processed. For example, block 315 may include documents that are in a different language, requiring block 330 to translate them. In addition, block 315 may consist of discrete transactions in a business system. In those cases, block 320 extracts the structure of those transactions, based on time stamps or automatically extracted keywords (using, for example, algorithms based on information theory, such as TextRank). The output of block 330 is used, through blocks 335 and 340, to train the hierarchical classification model in block 345, and the hierarchical topic model in block 350.

FIG. 4 of the embodiment is a block diagram that illustrates how, once the system has been trained as described in FIG. 3, documents and other artifacts that purport to serve as evidence the regulated entity's compliance with the documents input in blocks 310 and 315 are fulfilling their role. This includes determining whether there are areas defined in blocks 310 and 315 for which the regulated entity is not keeping written and objective evidence of its compliance.

Block 405 artifacts can include business process logs, device history records, batch history records, customer complaint investigations, Corrective and Preventive Action (CAPA) investigations, employment agreements, training materials, export declarations, technical report, and validation reports, to name a few examples. Blocks 410 and 415 carry out any pre-processing of the text data required before further processing. Given a particular artifact provided in blocks 405, block 420 consists of those areas of the policies, procedures, specifications and other input documents provided in block 310 and block 315 that apply to it. It performs this automatic classification by using the model trained in block 345. Block 425 extracts the topics present in the documents provided in block 405. Block 430 analyzes the topics extracted in block 425 with the applicable documents identified in block 420, providing the data to block 435. Block 435 uses this information, together with that provided by block 350, to output the Applicable Document Risk Index (440), and the Compliance Evidence Risk Index (445). Block 440 specifies how well all the applicable documents provided in block 310 and block 315 are covered by the evidence provided in block 405 while block 445 specifies the thoroughness with which the evidence artifacts provided in block 405 show compliance with the documents identified in block 420.

Another example of the first type of risk (those identified in block 440), would be that in block 315 there is mention of a specific dimensional characteristic of a product and in none of the evidence artifacts provided in block 405 there is mention that that specification is being tested or verified. An example of the second type of risk (those identified in block 445) may be that in block 310, one of the procedures provided as an input specifies that prior to exporting a product, the Embargoed and Sanctioned Country List, must be consulted, as defined in 15 CFR 746. An evidence artifact provided in block 405, consisting of an export transaction log, shows that the system and the employee in charge of the export process are in fact consulting that list. However, the current list does not include North Korea, which is specifically listed in 746.4.

Block 440 determines how well the different areas of an applicable set of policies are and the compliance evidence artifacts provided in block 405 covers procedures. These can be inferred by the classification probabilities output in block 420. That is, areas of the policies and regulations, as well as specifications, which are applicable but nonetheless have a low classification probability given the documents in block 405, are poorly covered and areas of high risk. In the case of block 445, this index can be calculated by a set similarity measure, such as the Jaccard index. If an artifact provided in block 405, for example, has a high Jaccard index, the risk that that document has missed important areas of highly rated classifications output in block 420 is low. If the Jaccard or other appropriate set similarity measurements are low, then the risk is high. As explained above, the Jaccard index can be obtained by comparing the set of words comprising highly ranked topics of the relevant documents identified in block 420 and the topics identified in block 340 with the set of words in the topics with high ranking, for a particular document, found in block 425.

The embodiment in FIGS. 3 and 4 can also be used recursively, in the sense that high-compliance evidence artifacts that are identified in the output to FIG. 4 can be provided to FIG. 3 in order to create a model that will be used in FIG. 4 to calculate the regulatory risk with respect to the exemplary, high-compliance artifacts provided to FIG. 3. Again, this will be useful to regulated entities since regulatory agencies do not only look for artifacts that unambiguously evidence the regulated entity's compliance, but also look for consistency between those artifacts. In this same way, artifacts with a poor regulatory compliance score can be input to FIG. 3, so that other artifacts that are given to FIG. 4 and that have the same types of deficiencies are identified as well, so companies can take action and correct those deficiencies in a timely manner.

Another exemplary embodiment is directed for use by a regulatory body to discover and highlight regulatory compliance risks within regulated entities. These risks may come from three main areas: (1) the policies, procedures, and work instructions that a regulated entity develops to fulfill regulatory obligations; (2) the evidence that regulated entities collect as part of the business operations; and (3) publicly available information, such as news articles, blog posts and social media. As an example of this last point, pharma and medical device companies are required to investigate any adverse reactions reported by patients or physicians, even those that are not communicated directly to the manufacturer but rather made public by other means (even word of mouth).

A regulatory body may train the system as noted in FIG. 1, but the inputs may be augmented by documented findings from investigations in other companies, or data that is shared from other regulatory agencies. For example, in this embodiment, block 130 may include the internal findings that the regulatory agency has identified within other companies. These findings, or the details about them, may not necessarily be public record, but are part of the records kept by the regulatory agency. Block 130 may also include findings from other regulatory bodies with which there could be an established relationship and agreement. For example, the Food and Drug Administration may reach an agreement with ANSM, which is the French government entity that deals with medical devices. The regulatory agencies may belong to the same government, of be different branches of the same regulatory agency.

Policies, procedures, work instructions and other documents collected from the regulated entity by the regulatory body through an investigation or through other regulatory processes, such as a new product marketing application, are analyzed by the system as noted in FIG. 2. This aids regulatory agency investigators by providing insight into which regulatory areas and regulated entity documents need to be examined in more detail.

A regulated entity does not only need to develop written policies and procedures to comply with regulations, but must also have written objective evidence that shows their thorough compliance with the regulation and their internal policies and procedures. Ensuring that this is the case is part of the regulatory body's responsibilities during an audit, or during the normal exercise of other regulatory processes such as pre-market applications (PMAs). The regulatory body will be able to use FIG. 3 to generate a model of how the regulated entity is supposed to comply with their own policies and procedures. The artifacts collected from the regulated entity, and shown in FIG. 4, serve to highlight areas of risk within the artifacts, and by consequence which business processes merit a closer look from the regulatory body. Similarly, FIG. 4 will highlight any areas within the regulated entity's policies, procedures, and work instructions for which there is inadequate evidence of compliance.

During the past decade, there has been a marked increase of not only the regulations that a regulatory body must enforce, but also of the instances in which a regulated entity must submit documentation to the regulatory agency for approval—prior to a product launch, changes in product specifications, intended use, or manufacturing processes. Regulatory bodies are hard pressed to provide a timely, thorough, and useful response to those submissions. Using systems such as the one described above, regulatory bodies will be able to more easily and quickly identify the areas in which they should devote their scarce resources.

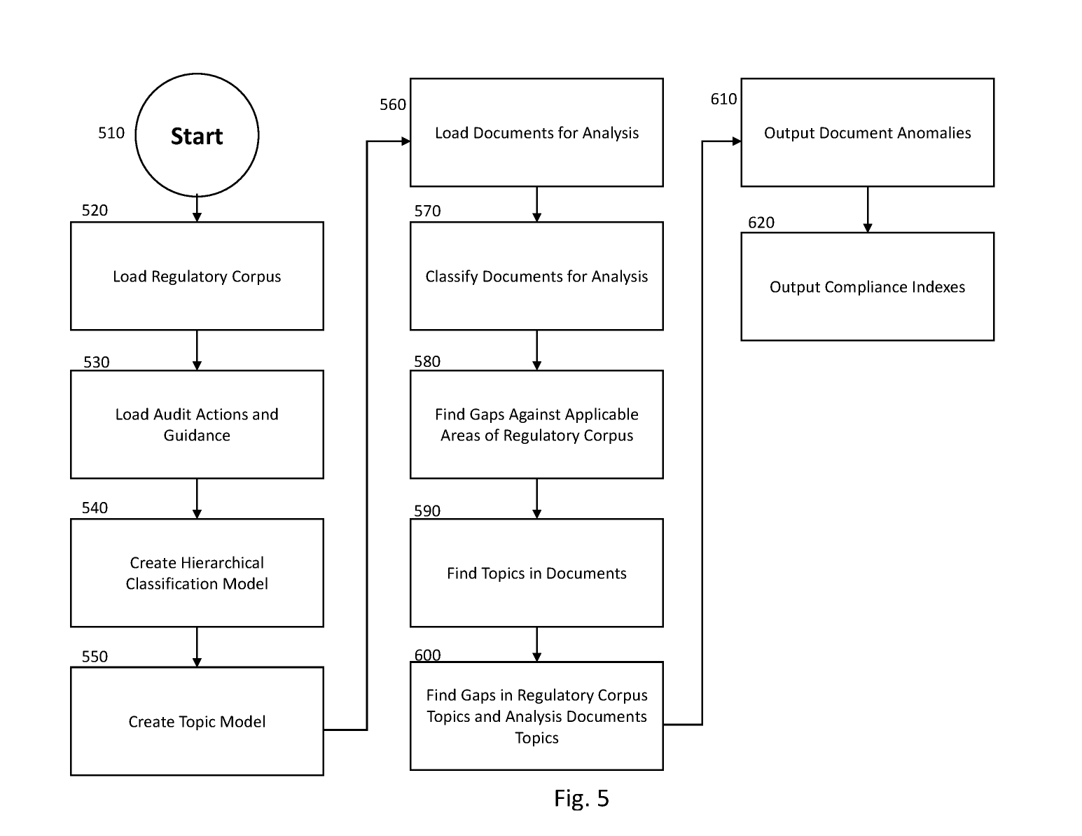

FIG. 5 shows the process by which an embodiment provides compliance risk indexes. When the embodiment is started at step 510, a regulatory corpus consisting of various regulations is loaded at step 520, which is further trained with internal audit actions and guidance documentation at step 530. A hierarchical classification model is then created in step 540, based on the hierarchy parsed from the text structure features present in the texts that comprise the regulatory corpus. In step 550, a topic model is created based on words extracted from the contents of the regulatory corpus. After both models are created, the embodiment receives documents for analysis in step 560. In steps 570 and 580, the embodiment determines which areas of the regulatory corpus are applicable and which are properly covered by the received documents by applying the classification model created in step 540 to the contents of the documents received in step 560. In steps 590 and 600, the topic model created in step 550 is used to determine how well the received documents cover the applicable parts of the regulatory corpus by comparing the topic model to the topics extracted from the contents of the documents received in step 560. The embodiment, in step 610, will then provide the analysis results showing what part of the applicable areas of the regulatory corpus are not properly covered by the received documents in step 560. In step 620, compliance indexes are provided based on how well the received documents cover the specific applicable areas of the regulatory corpus and how well the applicable areas of the regulatory corpus are covered by the received documents.

1. A computer software system for automated discovery and ranking of regulatory compliance risks, comprising:
a regulatory corpus;
a module for receiving one or more documents;
one or more classification models based on text structure features extracted from the contents of said regulatory corpus, which define a hierarchy of classifications;
one or more topic models based on words extracted from the contents of said regulatory corpus;
a module for determining the applicable parts of the regulatory corpus to said one or more received documents using said one or more classification models;
a module for determining the compliance level of said one or more received documents by comparing the topics in said one or more topic models for the applicable parts of the regulatory corpus to topics extracted from said one or more received documents;
a module for providing compliance risk ratings based on said determined applicable parts of the regulatory corpus and said compliance level of said one or more received documents.

2. The system of claim 1, where the regulatory corpus consists of one or more of:
State regulations;
Federal regulations;
case law;
law memoranda;
industry standards;
international standards
industry regulatory actions;
documented industry guidance;
documented industry best practices;
internal company rules;
internal company procedures;
audit findings;
internal audit findings;
news articles; and
expert opinions.

3. The system of claim 1, where the received one or more documents are of one or more of:
policies;
best practices;
industry professional bodies standards;
financial statements;
transaction logs;
process manuals;
engineering reports;
procedures;
work instructions;
business specifications; and
evidence artifacts.

4. The system of claim 1, further comprising a module to train said regulatory corpus by creating a new regulatory corpus comprising the contents of said regulatory corpus with additional sources of regulatory information;

5. The system of claim 4, where the additional sources of regulatory information are one or more of:
State regulations;
Federal regulations;
case law;
law memoranda;
industry standards;
industry regulatory actions;
documented industry guidance;
documented industry best practices;
internal company rules;
internal company procedures;
audit findings;
news articles; and
expert opinions.

6. The system of claim 4, where the additional sources of regulatory information are one or more of the received documents.

7. The system of claim 4, where updated compliance risk ratings are provided after the regulatory corpus has been trained.

8. A software-implemented method for automated discovery and ranking of regulatory compliance risks, comprising the steps of:
defining a regulatory corpus;
receiving one or more documents;
defining one or more classification models based on text structure features extracted from the contents of said regulatory corpus, which define a hierarchy of classifications;
defining one or more topic models based on words extracted from the contents of said regulatory corpus;
determining the applicable parts of the regulatory corpus to said one or more received documents using said one or more classification models;
determining the compliance level of said one or more received documents by comparing the topics in said one or more topic models for the applicable parts of the regulatory corpus to topics extracted from said one or more received documents;
providing compliance risk ratings based on said determined applicable parts of the regulatory corpus and said compliance level of said one or more received documents.

9. The method of claim 8, where the regulatory corpus consists of one or more of:
State regulations;
Federal regulations;
case law;
law memoranda;
industry standards;
international standards
industry regulatory actions;
documented industry guidance;
documented industry best practices;
internal company rules;
internal company procedures;
audit findings;
internal audit findings;
news articles; and
expert opinions.

10. The method of claim 8, where the received one or more documents are of one or more of:
policies;
best practices;
industry professional bodies standards;
financial statements;
transaction logs;
process manuals;
engineering reports;
procedures;
work instructions;
business specifications; and
evidence artifacts.

11. The method of claim 8, where said regulatory corpus is trained by creating a new regulatory corpus comprising the contents of said regulatory corpus with additional sources of regulatory information.

12. The method of claim 11, where the additional sources of regulatory information are one or more of:
State regulations;
Federal regulations;
case law;
law memoranda;
industry standards;
international standards
industry regulatory actions;
documented industry guidance;
documented industry best practices;
internal company rules;
internal company procedures;
audit findings;
internal audit findings;
news articles; and
expert opinions.

13. The method of claim 11, where the additional sources of regulatory information are one or more of the received documents.

14. The method of claim 11, where updated compliance risk ratings are provided after the regulatory corpus has been trained.

15. A non-transitory computer readable medium containing program instructions for causing a computer to perform the method of:
defining a regulatory corpus;
receiving one or more documents;
defining one or more classification models based on text structure features extracted from the contents of said regulatory corpus, which define a hierarchy of classifications;
defining one or more topic models based on words extracted from the contents of said regulatory corpus;
determining the applicable parts of the regulatory corpus to said one or more received documents using said one or more classification models;
determining the compliance level of said one or more received documents by comparing the topics in said one or more topic models for the applicable parts of the regulatory corpus to topics extracted from said one or more received documents;
providing compliance risk ratings based on said determined applicable parts of the regulatory corpus and said compliance level of said one or more received documents.

16. The computer readable medium of claim 15, where the regulatory corpus consists of one or more of:
State regulations;
Federal regulations;
case law;
law memoranda;
industry standards;
international standards
industry regulatory actions;
documented industry guidance;
documented industry best practices;
internal company rules;
internal company procedures;
audit findings;
internal audit findings;
news articles; and
expert opinions.

17. The computer readable medium of claim 15, where the received one or more documents are of one or more of:
policies;
best practices;
industry professional bodies standards;
financial statements;
transaction logs;
process manuals;
engineering reports;
procedures;
work instructions;
business specifications; and
evidence artifacts.

18. The computer readable medium of claim 15, where said regulatory corpus is trained by creating a new regulatory corpus comprising the contents of said regulatory corpus with additional sources of regulatory information.

19. The computer readable medium of claim 18, where the additional sources of regulatory information are one or more of:
State regulations;
Federal regulations;
case law;
law memoranda;
industry standards;
international standards
industry regulatory actions;
documented industry guidance;
documented industry best practices;
internal company rules;
internal company procedures;
audit findings;
internal audit findings;
news articles; and
expert opinions.

20. The computer readable medium of claim 18, where the additional sources of regulatory information are one or more of the received documents.
